(19) United States
(12) Patent Application Publication
(10) Pub. No.: US 2017/0146392 A1
(43) Pub. Date: May 25, 2017

(54) Weight Scale Data Hub

(71) Applicant: Under Armour, Inc., Baltimore, MD (US)

(72) Inventors: Mark A. Oleson, Baltimore, MD (US); F. Grant Kovach, Baltimore, MD (US); Nathan Dau, Baltimore, MD (US); Angela Nelligan, Baltimore, MD (US)

(21) Appl. No.: 14/947,342

(22) Filed: Nov. 20, 2015

(51) Int. Cl. G01G 23/36; G01G 23/42; H04Q 9/00

(52) U.S. Cl. CPC G01G 23/36; H04Q 9/00; G01G 23/42; H04Q 2209/43

(57) ABSTRACT

A device is provided for use by a user having a transmitter operable to transmit a data signal corresponding to previously recorded activity of the user. The device includes: a standing surface for supporting the user, a weight scale operable to output a weight signal based on the weight of the user supported by said standing surface; a receiver operable to receive the data signal; and a memory operable to store user data based on the received data signal.

### BACKGROUND

The present invention generally relates to devices and methods for downloading and displaying information.

There exists a need for a device and method to download and display information related to a user's activities.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1 illustrates an example wearable device recording exercise data while running;

FIG. 2 illustrates an example wearable device recording exercise data while swimming;

FIG. 3 illustrates an example wearable device recording exercise data while playing tennis;

FIG. 4 illustrates wearable devices downloading exercise data to a data hub in accordance with aspects of the present invention;

FIG. 5 illustrates a device to download exercise data in accordance with aspects of the present invention; and

FIG. 6 illustrates a process by which exercise data is downloaded in accordance with aspects of the present invention.

### DETAILED DESCRIPTION

### Overview

A device is provided for use by a user having a transmitter operable to transmit a data signal corresponding to previously recorded activity of the user. The device includes: a standing surface for supporting the user, a weight scale operable to output a weight signal based on the weight of the user supported by said standing surface; a receiver operable to receive the data signal; and a memory operable to store user data based on the received data signal.

### Example Embodiments

One of the recent trends in fitness is using a wearable device to record data related to the activity a user is performing. The data can be downloaded directly to a computer, smartphone, or other smart devices, and the user can refer to the downloaded data to track his progress. A wearable device may incorporate various sensors to determine activity levels. Non-limiting examples of such sensors include temperature sensors, pressure sensors, water sensors, moisture sensors, saline channel sensors, electric field sensors, current sensors, voltage sensors, impedance sensors, magnetic field sensors, accelerometers, altimeters, GPS sensors, magnetometers, optical sensors, and chemical sensors. Traditionally, a user may wear a single wearable device to record data related to all activities a user is performing. However, some wearable devices may be better at recording data from certain activities than others. For example, a shoe may be better equipped to measure the number of steps, ground force, and foot speed than a headband, but a headband may be better equipped to measure body temperature, pulse rate, and perspiration than a shoe. A user may therefore choose to wear more than one wearable device when performing activities.

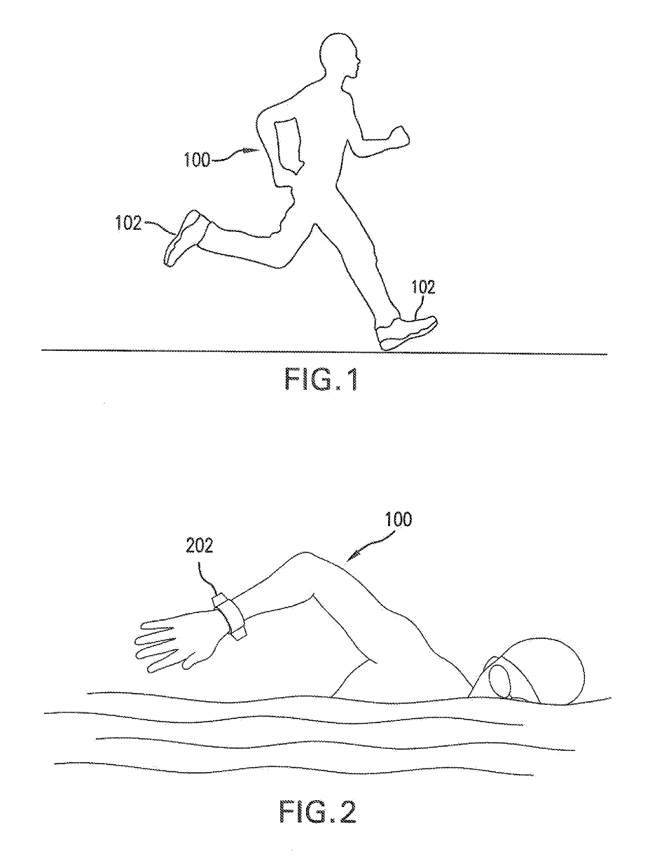

A user that has multiple wearable devices may desire to view the recorded data from all of his wearable devices at the same time, and even manipulate or combine the data to perform a more detailed analysis of his performance. FIGS. 1-3 discuss different types of smart wearable devices.

FIG. 1 illustrates an example wearable device recording exercise data while running.

As shown in the figure, user 100 is wearing shoes 102 while running. Shoes 102 are an example of a smart wearable device, and shoes 102 to record data associated with running. A smart wearable device is one that incorporates a computer chip into its design. The computer chip typically includes sensors, a memory that can store the data the sensors record, and a transmitter/receiver so that data, or functions thereof, can be uploaded/downloaded. The sensors inside shoes 102 may incorporate the types of sensors described above, they detect certain parameters associated with a user's activity, and those parameters are translated into data signals. These sensors can detect data signals including, but not limited to: foot force, running speed, distance covered, calories burned, pulse rate, fluid loss, gait length, and time. The computer chip may also manipulate the data signals to generate a signature that is a function of the data. Signatures may include, but are not limited to: amount of work done, change in calories burned over time, change in gait length over time, and combinations thereof.

In order to view the recorded data signals and signatures, shoes 102 must be tethered or otherwise connected to another device, as shoes 102 do not provide user 100 with a means to view the data signals or signatures. In many instances, shoes 102 are tethered, via a wireless or wired connection, to a smartphone so a user can upload the data to the phone follow the progress of his exercise regimen. In other embodiments, shoes 102 may be tethered to a computer, via a wireless or wired connection. In yet other embodiments, shoes 102 may be tethered, via a wireless or wired connection, to another smart device, like a smart television.

FIG. 2 illustrates another example wearable device recording exercise data while swimming.

As shown in the figure, user 100 is wearing a smartwatch 202 while swimming. Smartwatch 202 can record data signals associated with swimming in a manner similar to how shoes 102 record data signals associated with running, as discussed above. Non-limiting examples of the types of data signals that may be recorded include maximum speed, average speed, distance covered, stroke length, drag force, etc., and combinations thereof. The signal may be stored as the raw data recorded by smartwatch 202, but smartwatch 202 may also generate signatures based on the data, as described above with reference to FIG. 1. The signals and signatures recorded and generated by smartwatch 202 can be downloaded to a device equipped to receive the data, as described above.

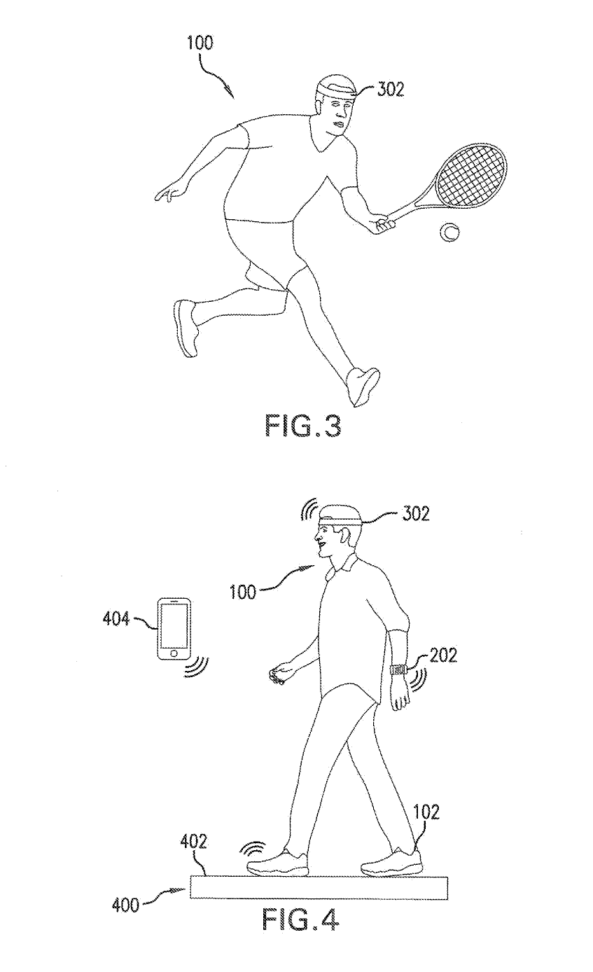

FIG. 3 illustrates another example wearable device recording exercise data while playing tennis.

As shown in the figure, user 100 is a wearing headband 302 while playing tennis. Headband 302 can record data signals associated with playing tennis in a manner similar to how shoes 102 record data signals associated with running, as discussed above. Non-limiting examples of the types of data signals that may be recorded include distance covered, backhand and forehand force, fluid loss, etc., and combinations thereof. The signal may be stored as the raw data recorded by headband 302, but headband 202 may also generate signatures based on the data, as described above with reference to FIG. 1. The signals and signatures recorded and generated by headband 302 can be downloaded to a device equipped to receive the data, as described above.

In accordance with aspects of the present invention a weight scale is a data hub for collecting, storing and managing exercise data from a plurality of a user's wearable smart devices and phones. Beneficial aspects of the data hub include the use of a single processing center that may provide “heavy lifting” with respect to processing data so as to maximize power savings of the plurality of the user's wearable smart devices and phones.

Example embodiments of a weight scale data hub in accordance with aspects of the present invention will now be described with additional reference to FIGS. 4-6.

FIG. 4 illustrates a user downloading exercise data in accordance with aspects of the present invention.

As shown in the figure, user 100 is standing on a scale 400 while a mobile phone 404 is nearby. User 100 is wearing shoes 102, smartwatch 202, and headband 302. Scale 400 includes a standing surface 402.

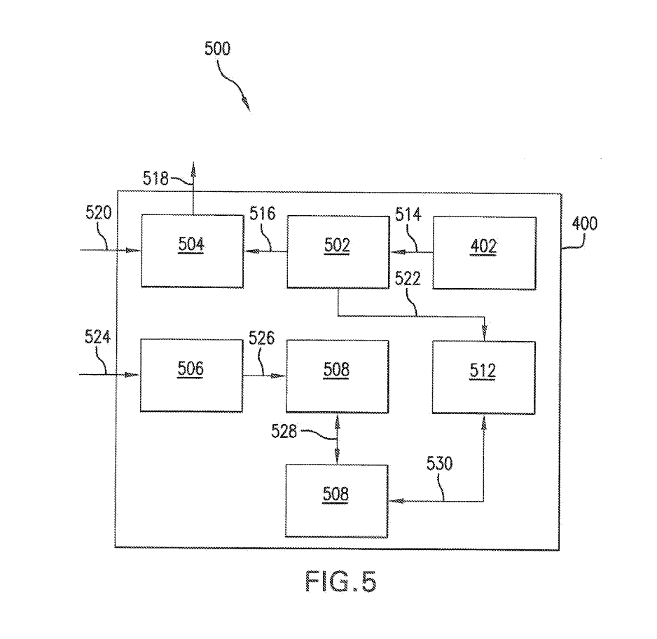

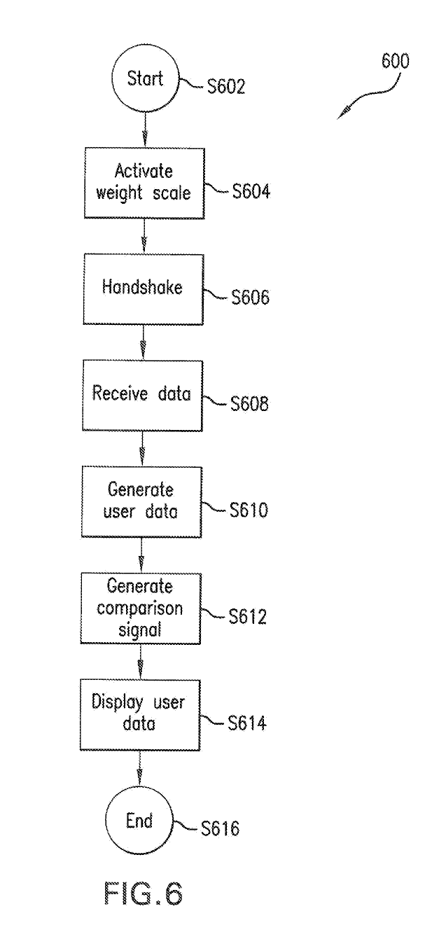

The operation of scale 400 will be further described with additional reference to FIGS. 5-6.

FIG. 5 illustrates a block diagram 500 of scale 400 of FIG. 4 for receiving downloaded exercise data in accordance with aspects of the present invention.

As shown in the figure, scale 400 includes standing surface 402, a weight scale 502, a transmitter 504, a receiver 506, a memory 508, a processor 510, and a display 512.

Standing surface 402 is the portion of scale 400 the user stands on when the user desires to view how much he weighs. Standing surface 402 is operable to communicate with weight scale 502.

Weight scale 502 communicates with standing surface 402 via a communication channel 514, transmitter 504 via a communication channel 516, and display 512 via a communication channel 522. Weight scale 502 may be any device or system that is able to determine the weight of a user. In this embodiment, weight scale 502 is additionally able to generate and signal to transmitter 504 based on the user standing on standing surface 402.

Display 512 may be any known type of display that is able to provide information to the user. Display 512 additionally processor 510 via a communication channel 530.

Transmitter 504 receives information from weight scale 502, via communication channel 516 and is able to transmit various wearable devices, via communication channel 520, and can transmit information to various wearable devices via communication channel 518.

Receiver 506 communicates with memory 508 via communication channel 526 and various wearable devices via communication channel 524. Receiver 506 may receive data from various wearable devices in any known manner, non-limiting examples of which include via a Bluetooth signal, a Wi-Fi signal and an RF signal. Receiver 506 receives data from various wearable devices, and sends the data to memory 508.

Memory 508 communicates with receiver 506 via communication channel 524 and processor 510 via communication channel 528. Memory 508 may be any device or system that is able to receive, store, retrieve and manage data, non-limiting examples of which include random access memory (RAM), static RAM (SRAM), dynamic RAM (DRAM), flash, disk, etc.

As shown in the figure, standing surface 402, weight scale 502, transmitter 504, receiver 506, memory 508, processor 510, and display 512 are shown as separate components. However, in some embodiments, at least two of standing surface 402, weight scale 502, transmitter 504, receiver 506, memory 508, processor 510 and display 512 may be combined as a single component. Still further, in some embodiments, processor 510 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

The interaction between standing surface 402, weight scale 502, transmitter 504, receiver 506, memory 508, processor 510, and display 512 will be further described with reference to FIG. 6.

FIG. 6 illustrates a process 600 by which exercise data is downloaded in accordance with aspects of the present invention.

For purposes of discussion, presume that a user has performed various activities and/or exercises, data for which has been stored on a plurality of smart wearable devices of the user. As a non-limiting example, presume that the user has run 2 miles, wherein data associated with the 2-mile run is stored in a wireless communication processor in shoe 102 of FIG. 1. Then, presume that same user played a 5-set tennis match, wherein data associated with the 5-set tennis match is stored in a wireless communication processor in headband 302 of FIG. 3. Finally, presume that the same user then swam 1 mile, wherein data associated with the 1-mile swim is stored in a wireless communication processor in smartwatch 202 of FIG. 1.

After completing the various activities, the user desires to see the recorded data for the day. Further, in some cases, the user may also desire to see how the recorded data for the day compares to data previously recorded. A data hub in accordan aspects of the present invention enables these features.

Each wearable device has recorded and stored its own data, and the user wants to see the data in a manner that is easy to understand. In some embodiments, the recorded data is transferred to an intermediate device, like a mobile phone, as a first step, and then the data is transferred from the intermediate device to the scale. In other embodiments, the recorded data is transferred directly from the wearable devices to the scale. Regardless of the location of the data, FIG. 6 illustrates a non-limiting example of how the data may be transferred to the scale.

As shown in the figure, process 600 starts (S602) and scale 400 is activated (S604). For example, returning to FIG. 4, user 100 steps on to standing surface 402 after performing various activities and exercises. Referring now to FIG. 5, standing surface 402 communicates with weight scale 502 and informs weight scale 502 that user 100 is standing on scale 400. Weight scale 502 then provides display 614 with the weight of user 100, and display 614 displays the weight of user 100.

Returning to FIG. 6, after the scale is activated (S604), there is a handshake between the scale and one or more wearable devices (S606). The handshake secures a connection between the scale and the one or more wearable devices to provide for a data download. For example referring to FIG. 5, weight scale 502 notifies transmitter 504 that it must broadcast a constant handshake signal and look for a return handshake signal from one or more wearable devices. The handshake signals broadcast and transmitted may be any known handshake protocol.

Returning to FIG. 4, shoes 102, smartwatch 202, and headband 302 are sending handshake signals when user 100 is on scale 400. Each of shoes 102, smartwatch 202, and headband 302 also receive the handshake signal from scale 400. Returning to FIG. 5, transmitter 504 receives the handshake signals from shoes 102, smartwatch 202, and headband 302. With handshake signals both sent and received from transmitter 504, shoes 102, smartwatch 202, and headband 302, scale 400 is ready to download data from the wearable devices.

In another embodiment, and with reference to FIG. 4, shoes 102, smartwatch 202, and headband 302 may first secure a handshake connection with mobile phone 404, and mobile phone 404 may then secure a handshake connection with scale 400. Data would then be downloaded from mobile phone 404 instead of shoes 102, smartwatch 202, and headband 302. Mobile phone 404 may contain an application that connects with each of shoes 102, smartwatch 202, headband 302, and scale 400 to facilitate the connection and data transfer.

Referring back to FIG. 6, after the handshake (S606) the scale then receives data (S608). Returning to FIG. 4, with the handshakes between devices complete, shoes 102, smartwatch 202, and headband 302 send activity data to scale 400 wirelessly. The wireless data transfer can occur via a wireless internet connection, Bluetooth connection, or any other wireless connection suitable for transferring data. Returning to FIG. 5, receiver 506 receives the data from shoes 102, smartwatch 202, and headband 302, and provides the data to memory 508. The data recorded by shoes 102, smartwatch 202, and headband 302 is downloaded to scale 400 as different data signals. Memory 508 may store data from a plurality of different wearable devices and a plurality of different exercise sessions. All data downloaded to memory 508 will have a specific signal based on the type of exercise or activity, and the date or time at which the activity occurred.

In another embodiment, the user may wear a single wearable device that records the data for all activities. In this case, the data from all the activities will be downloaded from the single wearable device as opposed to multiple wearable devices, as described above. Scale 400 would be able to differentiate between different activities based on the data signals that correspond to the different activities the user performs.

In some embodiments, communication between scale 400 and the wearable devices may occur in series. As a non-limiting example, scale 400 may first execute a handshake with shoes 102 and then download data from shoes 102, then execute a handshake with smartwatch 202 and then download data from smartwatch 202, then execute a handshake with headband 302 and then download data from headband 302.

In other embodiments, communication between scale 400 and the wearable devices may occur in parallel, where all handshakes are completed at the same time, and then all data is downloaded at the same time.

In some embodiments, the data from each wearable device is stored separately within memory 508 such that the user can view data associated with a single wearable device (for example, how far the user ran in shoes 102). In other embodiments, the data from one or more wearable devices is combined such that the user can view the totals from the data taken from each wearable (for example, how many total calories the user burned during the day).

Referring back to FIG. 6, after the data is received (S608) the user data is generated (S610). Returning to FIG. 5, memory 508 provides data signals from the downloaded data to processor 510.

In some embodiments, processor 510 creates a signature based on the signals from the downloaded data. As a non-limiting example, processor 510 may receive data signals regarding a user's running, swimming, and tennis activity for the day. Processor 510 may combine those signals in a predetermined manner to create a signature based on the combination of the day's activities. For example, the signature may include information of the total distance covered, the user's average heart rate, the total number of calories burned, or any other data that may be relevant to the user regarding the day's activities. After generating the user data, processor 510 may transmit the user data back to memory 508 as a signature to be stored.

In other embodiments, processor 510 may maintain separation of the data signals provided by the respective wearable devices. Further, processor 510 may process data signals provided by the respective wearable devices in a different predetermined manner. In any event, processor 510 may then transmit the individual data sets from the respective wearable devices to memory 508 to be stored.

Returning to FIG. 6, after the user data is generated (S610) a comparison signal is generated (S612). For example, returning to FIG. 5, processor 510 notifies memory 508 that memory 508 needs to provide the signatures (or in the case where a signature was not stored, then the individual data sets) from the current day's activities and from a previous day's activities to processor 510. In some embodiments, the current day's activities may be compared with the immediate previous day's activities. In some embodiments, the current day's activities may be compared with the most recent day's activities for which exercise was recorded. In some embodiments, the current day's activities may be compared with a predetermined plurality of previous days' activities. In some embodiments, the current day's activities may be compared with an average of a predetermined number of previous days' activities.

Memory 508 then provides the requested signatures (or individual data sets) to processor 510, and processor 510 proceeds to generate a comparison signal based on the comparison between the two signatures received. The comparison signal serves to provide a comparison between the levels of activity in which the user engaged during the two days being compared. In other embodiments, various comparisons may be made, and comparisons are not limited to comparisons between two consecutive days. As non-limiting examples, comparisons may be made between groups of days, or if the user performs the same exercise every Monday, for example, comparisons may be made between various Mondays.

As a non-limiting example, presume that at a time t₁ the user downloaded data from shoes 102, smartwatch 202, and headband 302, at a time t₂ the user downloaded data from smartwatch 202 and headband 302, and at time t₃ the user downloaded data from shoes 102, smartwatch 202, and headband 302. In creating comparison signals, in some embodiments, processor 510 may only generate a comparison signal between comparable data sets.

In the above example, processor 510 may generate a comparison signal based on the combination of data from all three wearable devices from times t₁ and t₃, but the data from t₂ would not be available for comparison because there is no data available from shoes 102 at time t₂. Processor 510 may generate a comparison signal based on data from smartwatch 202 and headband 302 at times t₁, t₂, and t₃ because data is available for those wearable at all three times.

Returning to FIG. 6, after the comparison signal is generated (S612) the user data is displayed (S614). For example, referring back to FIG. 5, processor 510 provides the comparison signal to display 512, and display 512 displays the comparison information to the user. Returning to FIG. 4, user 100 may view the comparison information on display 512 on scale 400. As a non-limiting example, display 512 may show user 100 that he ran 3 more miles than he ran yesterday, and he burned 500 more calories than yesterday. As described above, there are many different types of comparisons that can be generated and communicated to user 100.

In an another embodiment, after downloading the exercise and activity data to scale 400, user 100 may want to view the data on a larger screen or he may want to manipulate the data in more depth than scale 400 allows. In this case, scale 400 may be equipped to transmit data or comparison signals to another device, like a laptop or table computer. For example, user 100 may want to display his exercise performance over the last year in a graphical format, which may be easier to do on a computer.

In some embodiments, scale 400 may upload data to another device. Such an upload may occur whenever data is downloaded to scale 400, or at predetermined times.

Returning to FIG. 6, after the data is displayed (S614), process 600 ends (S616).

The above discussed non-limiting example deals with a scale being used as a data hub for multiple wearable smart devices. However, in another embodiment, user 100 may only use a single wearable device when performing multiple exercises. The single wearable device may record the data from all different exercises and activities user 100 performs throughout the day, and the data would have different signals based on the activity being performed, as previously described. When user 100 steps on standing surface 402, the data from the single wearable device downloads to scale 400, and scale 400 can differentiate the data based on the signals that correspond to different activities or exercises. Scale 400 can then show user 100 his progress, as previously described.

The present invention provides a device and method to wirelessly download data from a wearable device to a scale. The scale is able to compare exercise and activity data from previous days or previous exercise sessions to notify the user of his progress.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A device for use by a user having a transmitter operable to transmit a data signal corresponding to previously recorded activity of the user, said device comprising:
a standing surface for supporting the user,
a weight scale operable to output a weight signal based on the weight of the user supported by said standing surface;
a receiver operable to receive the data signal; and
a memory operable to store user data based on the received data signal.

2. The device of claim 1, further comprising a display operable to display a weight of the user and to display additional user data based on the stored user data.

3. The device of claim 2, further comprising:
a processing component,
wherein said receiver is operable to receive the data signal as a first data signal and a second data signal,
wherein said processing component is operable to generate the user data as a first signature based on the first data signal and the second data signal,
wherein said memory has a second signature stored therein,
wherein said processing component is further operable to generate a comparison signal based on a comparison of the first signature and the second signature, and
wherein said display is operable to display the additional user data based on the comparison signal.

4. The device of claim 3, further comprising a transmitter operable to transmit a handshake signal to the transmitter when said standing surface supports the user.

5. The device of claim 3, further comprising a transmitter operable to transmit the additional user data to a second receiver.

6. The device of claim 1, further comprising:
a processing component,
wherein said receiver is further operable to receive a second data signal from a second transmitter associated with the user,
wherein said processing component is operable to generate the user data as a first signature based on the data signal and the second data signal,
wherein said memory has a second signature stored therein,
wherein said processing component generates comparison signal based on a comparison of the first signature and the second signature, and
wherein said display is operable to display the additional user data based on the comparison signal.

7. The device of claim 6, further comprising a transmitter operable to transmit a handshake signal to the transmitter when said standing surface supports the user.

8. The device of claim 6, further comprising a transmitter operable to transmit the additional user data to a second receiver.

9. The device of claim 1, further comprising a transmitter operable to transmit a handshake signal to the transmitter when said standing surface supports the user.

10. The device of claim 9, further comprising a transmitter operable to transmit the additional user data to a second receiver.

11. The device of claim 1, further comprising a transmitter operable to transmit the additional user data to a second receiver.

12. The device of claim 1, wherein said receiver is operable to receive the data signal as one of the group consisting of a Bluetooth signal, a Wi-Fi signal and an RF signal.

13. The device of claim 12, wherein said receiver is operable to receive the data signal as a Bluetooth signal.

14. The device of claim 12, wherein said receiver is operable to receive the data signal as a Wi-Fi signal.

15. The device of claim 12, wherein said receiver is operable to receive the data signal as an RF signal.
